(19) United States
(12) Patent Application Publication
(10) Pub. No.: US 2019/0273341 A1
(43) Pub. Date: Sep. 5, 2019

(54) High Speed Connector

(71) Applicant: Dell Products L.P., Round Rock, TX (US)

(72) Inventors: Umesh Chandra, Santa Cruz, CA (US); Sandor Farkas, Round Rock, TX (US); Bhyrav M. Mutnury, Austin, TX (US)

(21) Appl. No.: 15/909,802

(22) Filed: Mar. 1, 2018

(51) Int. Cl. H01R 13/646; H01R 12/71; H01R 13/26; H01R 13/03

(52) U.S. Cl. CPC H01R 13/646; H01R 12/71; H01R 12/777; H01R 13/03; H01R 13/26

(57) ABSTRACT

In accordance with some embodiments of the present disclosure, a connector may include a housing and a pin housed in the housing and configured to electrically couple to a corresponding electrically-conductive conduit of a device comprising the connector. A body of the pin is formed of a material having a first conductivity. The pin may include a first portion between a proximal point of the pin and a medial point of the pin, and a second portion between the medial point of the pin and a distal point of the pin. The medial point of the pin is proximate to a point of electrical contact of the pin with another pin. The second portion is at least partially covered by a layer of material having a second conductivity that is lower than the first conductivity.

### BACKGROUND

The present disclosure relates generally to information handling systems, and more particularly, to a connector for providing high-speed signal transfer between electrical components.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Various hardware components of information handling systems are electrically connected in order to provide or allow for the transfer or communication of signals from one component to another. These connections can be made through the use of various wiring, lines, plugs, pins, slots, sockets, etc., for example, on a printed circuit board (PCB), midplane, backplane, rack system, etc. to or through which the hardware components are mounted or attached.

It is becoming increasingly challenging to ensure signal quality for these components that are connected to each other through multiple connectors. Next generation modular designs are intended to support 32-56 Gbps technologies through PCBs, midplanes, backplanes, etc. Accordingly, it would be desirable to provide an improved connector technology to ensure support for the high speed signal rates of next generation technology.

### SUMMARY

In accordance with the teachings of the present disclosure, the disadvantages and problems associated with resonance in connector stubs have been reduced or eliminated.

In accordance with some embodiments of the present disclosure, a connector may include a housing and a pin housed in the housing and configured to electrically couple to a corresponding electrically-conductive conduit of a device comprising the connector. A body of the pin is formed of a material having a first conductivity. The pin may include a first portion between a proximal point of the pin and a medial point of the pin, and a second portion between the medial point of the pin and a distal point of the pin. The medial point of the pin is proximate to a point of electrical contact of the pin with another pin. The second portion is at least partially covered by a layer of material having a second conductivity that is lower than the first conductivity.

In accordance with some embodiments of the present disclosure, a method for forming a connector, includes constructing a body of a pin from a material having a first conductivity. The pin has a first portion between a proximal point of the pin and a medial point of the pin, and a second portion between the medial point of the pin and a distal point of the pin, the medial point of the pin being proximate to a point of electrical contact of the pin with another pin. The method also includes at least partially covering the second portion of the pin with a layer of material having a second conductivity that is lower than the first conductivity.

Technical advantages of the present disclosure may be readily apparent to one skilled in the art from the figures, description and claims included herein. The advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments;

FIGS. 2A and 2B each illustrate a cross-sectional elevation view of selected components of connectors for use in a mating blade architecture;

FIGS. 3A and 3B each illustrate a cross-sectional elevation view of selected components of connectors for use in a mating beam architecture;

FIG. 4 is a chart plotting resonance loss against frequency for various configurations of connectors;

FIG. 5A illustrates a cross-sectional elevation view of selected components of another beam-type connector, in accordance with embodiments of the present disclosure;

FIGS. 5B and 5C each illustrate an isometric view of a pin of the beam-type connector depicted in FIG. 5A, in accordance with embodiments of the present disclosure;

FIG. 6 is a flow diagram for a method of manufacturing a connector, in accordance with embodiments of the present disclosure.

### DETAILED DESCRIPTION

In the following description specific details are set forth describing certain embodiments. It will be apparent to one skilled in the art, however, that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU), graphics processing unit (GPU), or other hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Additionally, some embodiments of information handling systems include non-transient, machine-readable media that include executable code that when run by a processor, may cause the processor to perform various steps or tasks. Some common forms of machine-readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

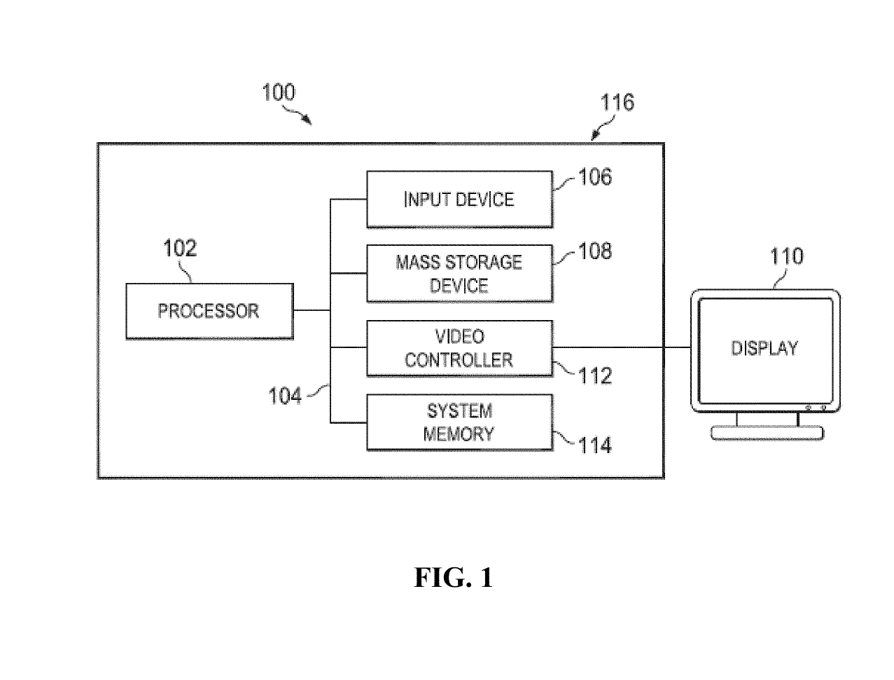

As an example, FIG. 1 depicts an information handling system (IHS) 100 that includes a plurality of network devices. As shown, IHS 100 includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mice, trackballs, and trackpads, and/or a variety of other input devices. Programs and data are stored on a mass storage device 108, which is coupled to processor 102. Examples of mass storage devices may include hard disks, optical disks, magneto-optical disks, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

An information handling system, such as IHS 100, may include one or more circuit boards operable to mechanically support and electrically couple electronic components making up the information handling system. For example, circuit boards may be used as part of motherboards, memories, storage devices, storage device controllers, peripherals, peripheral cards, network interface cards, and/or other electronic components. As used herein, the term “circuit board” includes printed circuit boards (PCBs), printed wiring boards (PWBs), etched wiring boards, and/or any other board or similar physical structure operable to mechanically support and electrically couple electronic components. The circuit board is configured to provide structural support for one or more information handling resources of information handling system and/or electrically couple one or more of such information handling resources to each other and/or to other electric or electronic components external to information handling system.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

As is known in the art, a circuit board may comprise a plurality of conductive layers separated and supported by layers of insulating material laminated together, with conductive traces disposed on and/or in any of such conductive layers. As is also known in the art, connectivity between conductive traces disposed on and/or in various layers of a circuit board may be provided by conductive vias. In some embodiments, the circuit board may comprise a circuit board having one or more connectors such as those connectors disclosed herein.

To electrically couple various components in an IHS, such as IHS 100 shown in FIG. 1, electrical connectors may be used. In some embodiments for example, the connectors can connect circuit boards together or couple a circuit board to a cable comprising electrically conductive wires, each of which can provide for transfer of one or more signals to communicate data, information, etc. between components of an IHS. One or more of these connectors can be incorporated, for example, in various sockets, pins, plugs, etc., such as QSFP28, QSFP-DD, OSFP connector systems, plated through-hole connector, surface mount connectors, co-planar connectors, orthogonal connectors, and mezzanine connectors, as understood to one of skill in the art. The connectors may be implemented or employ a connector mating architecture, typically, but not always, comprising male and female portions.

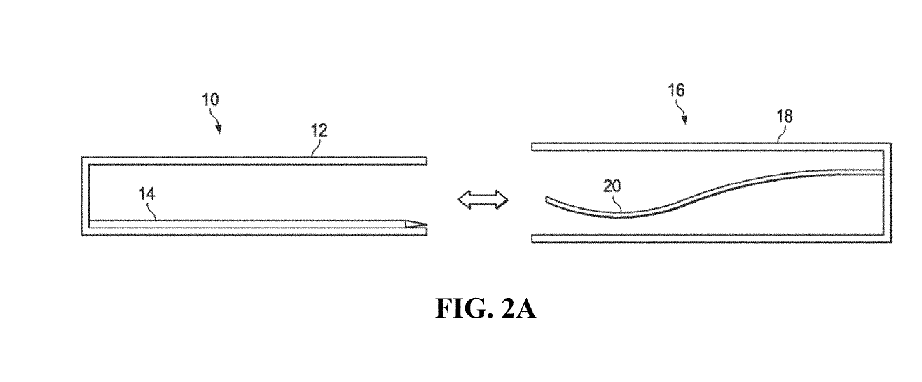

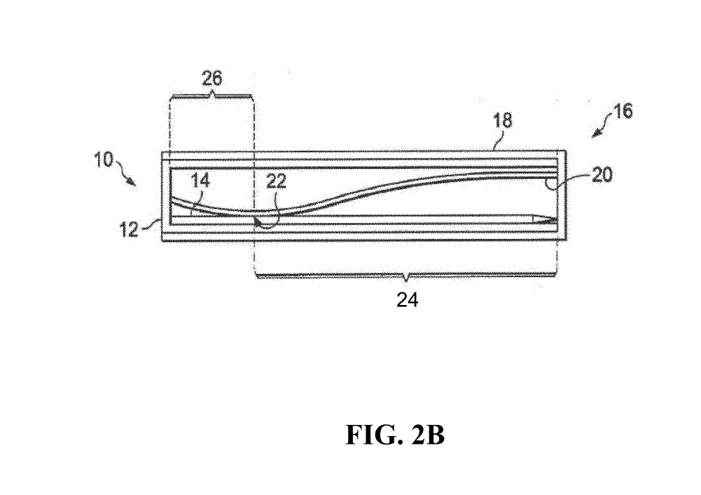

One type of mating between connectors may be referred to as a mating blade architecture, depicted in FIGS. 2A and 2B. In a mating blade architecture, a first connector 10 may comprise a housing 12 (e.g., constructed of plastic or other suitable material) which houses one or more blade pins 14 electrically coupled via the connector to corresponding electrically-conductive conduits (e.g., wires of a cable, vias/traces of a circuit board, and/or the like). A second connector 16 of the mating blade architecture may include a housing 18 (e.g., constructed of plastic or other suitable material) which houses one or more beam pins 20. To couple first connector 10 and second connector 16, a force may be applied to one or both of first connector 10 and second connector 16 in the direction of the double-ended arrow shown in FIG. 2A, such that each blade pin 14 slides under the upwardly-curving portion of a corresponding beam pin 20, to electrically couple each blade pin 14 to its corresponding beam pin 20 at a contact point 22 as shown in FIG. 2B.

As a result of the coupling between a blade pin 14 and its corresponding beam pin 20, portions of each of blade pin 14 and beam pin 20 may be “unused” in the sense that such portions are present but not needed to conduct a signal between blade pin 14 and beam pin 20. Rather, such portions are present to create mechanical features ensuring the physical mating of connectors 10 and 16. For example, as can be seen from FIG. 2B, blade pin 14 may have an unused portion or “stub” 24 (“primary” stub) which is not part of an electrically conductive path between blade pin 14 and beam pin 20, and beam pin 20 may also have an unused portion or stub 26 (“secondary” stub) which is not part of an electrically conductive path between blade pin 14 and beam pin 20.

Each stub 24 and 26 may act as an antenna, and thus may resonate at frequencies (and harmonics thereof) for which the length of such stub 24 or 26 is equal to one-quarter of the wavelength of such frequencies. As transmission frequencies used in the communication pathways of information handling systems increase, signals operating at such frequencies may be affected by such resonances, resulting in decreased signal integrity.

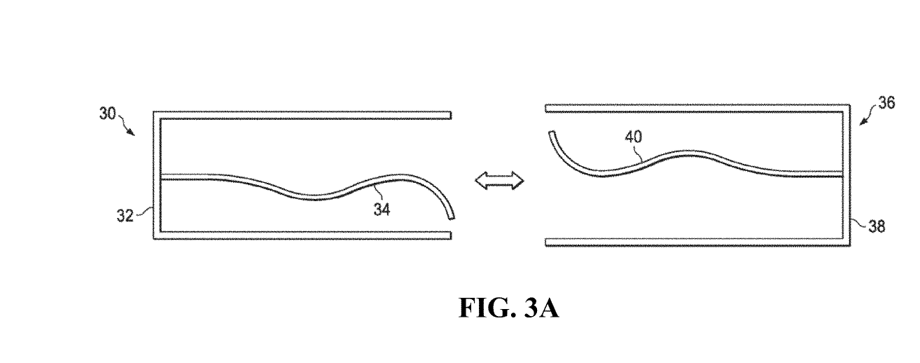

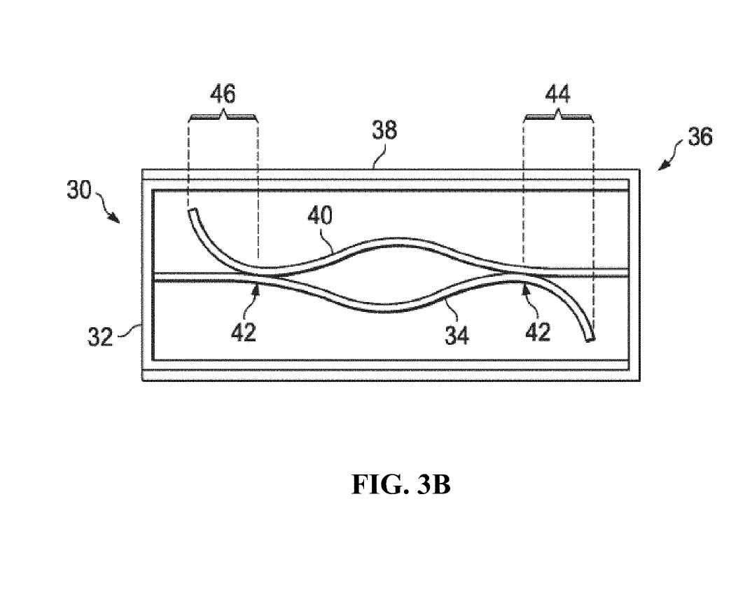

Some approaches may be employed to mitigate the effect of stub resonances, but such approaches still have disadvantages. For example, an alternative to the mating blade architecture, and known as a mating beam architecture, is depicted in FIGS. 3A and 3B. In a mating beam architecture, a first connector 30 may comprise a housing 32 (e.g., constructed of plastic or other suitable material) which houses one or more first beam pins 34 electrically coupled via the connector to corresponding electrically-conductive conduits (e.g., wires of a cable or vias/traces of a circuit board). A second connector 36 of the mating blade architecture may include a housing 38 (e.g., constructed of plastic or other suitable material) which houses one or more second beam pins 40. To couple first connector 30 and second connector 36, a force may be applied to one or both of first connector 30 and second connector 36 in the direction of the double-ended arrow shown in FIG. 3A, such that each first beam pin 34 slides under the upwardly-curving portion of a corresponding second beam pin 40, to electrically couple each first beam pin 34 to its corresponding second beam pin 40 at multiple contact points 42 as shown in FIG. 3B. While this architecture may eliminate the mating blade stub of one connector (e.g., the “primary” stub), this architecture still includes two stubs 44 and 46 (each a “secondary” stub) which may each cause undesirable resonances.

“Secondary” stubs are common in connector arrangements, and cannot be removed without affecting the mechanical design and manufacturability yield. Any stub (e.g., stubs 24, 26 in FIG. 2B, and/or stubs 44, 46 in FIG. 3B) is generally undesirable as it potentially creates resonance—a reflected signal, which is delayed and added to the original signal that is communicated over the connection architecture—potentially resulting in some distortion to the signal. In some examples, once the signal is distorted, it is very difficult to undo this effect at the component receiving the signal, leading to, for example, increased bit errors.

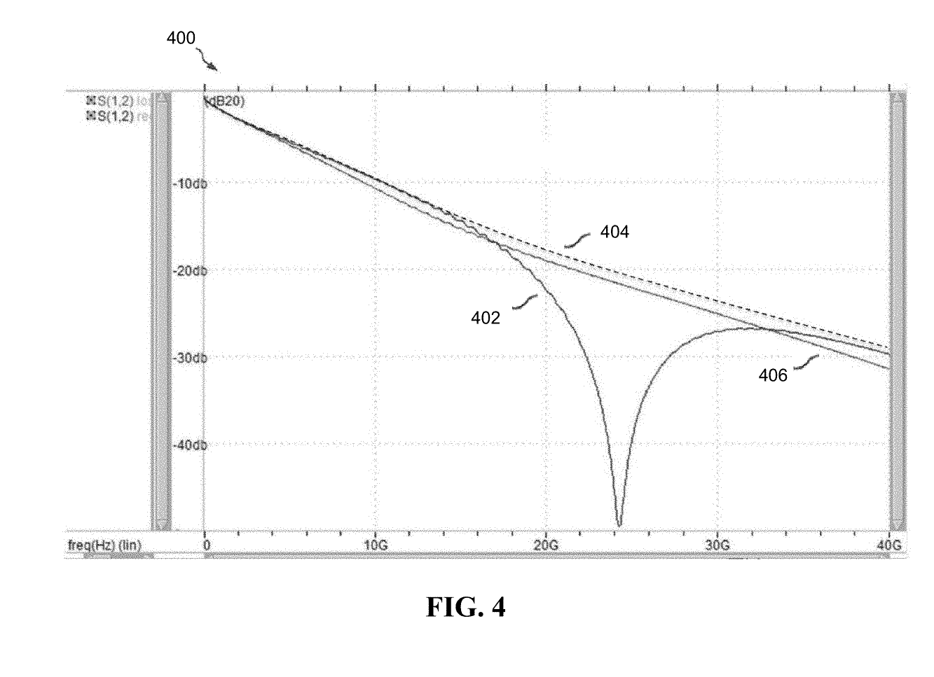

Resonance due to “secondary” stubs is of limited concern for older generations of signaling between electronic components, but as the signaling speeds continue to increase, the secondary stub resonance starts to pose a significant problem for signal integrity. In some examples, the length of a secondary stub is on the order of 10s of mils, and higher frequency (e.g., 32 Gbps or higher, or 64 GHz or higher) signals are typically highly impacted by the secondary stub resonance. This is illustrated, for example, by the line 402 in FIG. 4, showing that in some embodiments for a connector of the mating beam architecture (e.g., as depicted in FIGS. 3A and 3B), the secondary stub causes a resonance loss of about 30 db at 25 GHz (50 Gbps). As the industry moves to ever higher frequency (e.g., from 32 Gbps to 56 Gbps), resonance due to secondary stubs is expected to substantially impact signal integrity margins and force designers to spend time and money improving the entire channel.

To address the issue of resonance attributable to stubs in connector arrangements, a mechanism for connector beam mating is herein described, which significantly reduces the impact of the secondary stubs while maintaining mechanical reliability.

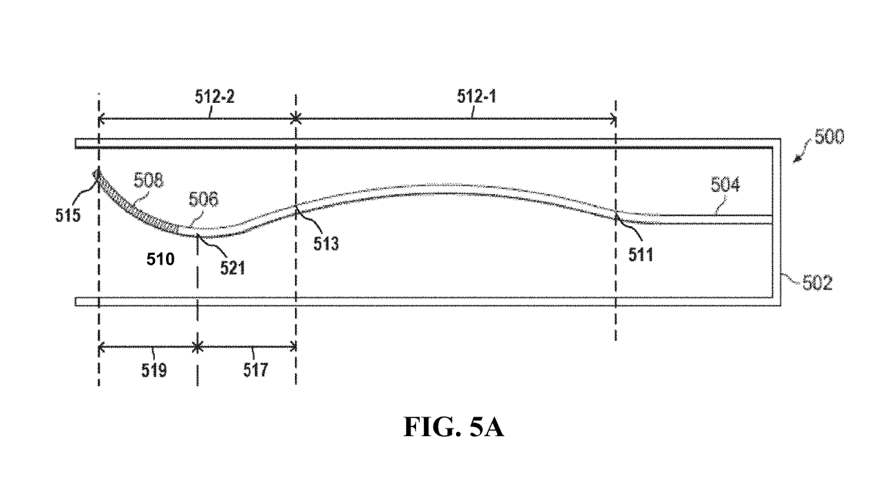

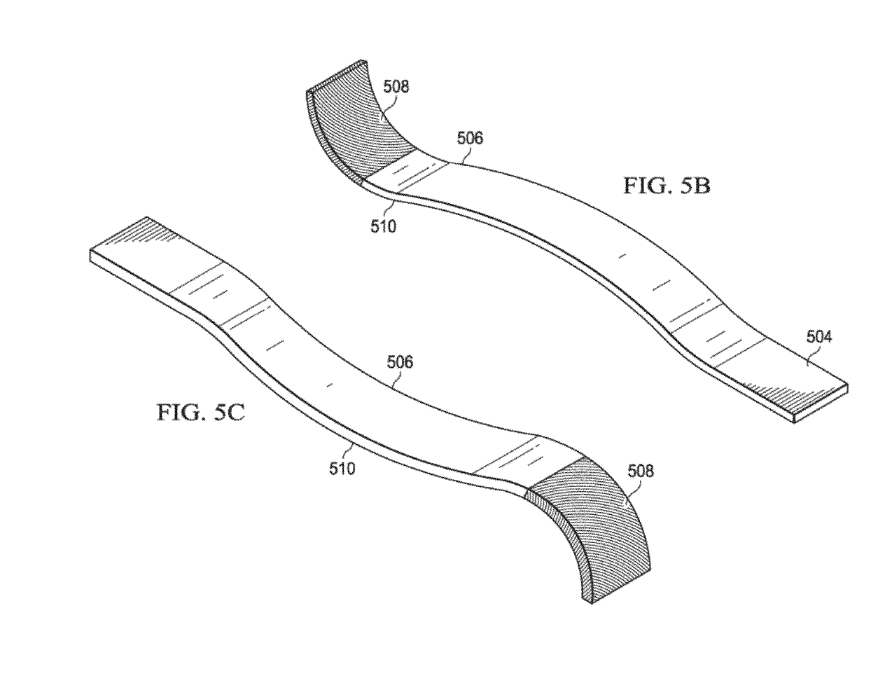

FIG. 5A illustrates a cross-sectional elevation view of selected components of a beam-type connector 500, and FIGS. 5B and 5C each show an isometric view of a beam pin 504 for use in beam-type connector 500, in accordance with embodiments of the present disclosure. As shown in FIG. 5A, connector 500 may comprise a housing 502 (e.g., constructed of plastic or other suitable material) which houses one or more beam pins 504 electrically coupled via the connector to corresponding electrically-conductive conduits (e.g., wires of a cable, vias/traces of a circuit board, and/or the like). In some examples, the body of beam pin 504 may be formed of any suitable material for providing electrical and mechanical connection, such as, for example, copper, aluminum, silver, gold, and/or some alloy of the same and/or the like, with a relatively high conductivity. In some embodiments, all or a portion of the primary body material (e.g., copper) may be coated, plated, or covered with another material, such as, for example, gold, to provide resistance to corrosion.

The beam pin 504 illustrated in FIG. 5A includes two curved portions of opposite concavity, namely, a first curved portion 512-1, extending between a proximal point 511 of beam pin 504 and a medial point 513 of beam pin 504, and a second curved portion 512-2, extending between the medial point 513 of beam pin 504 and a distal point 515 of beam pin 504. The first curved portion 512-1 illustrated in FIG. 5A has a downward concavity while the second curved portion 512-2 has an upward concavity as shown in the orientation of FIG. 5A. Second curved portion 512-2 of the beam pin 504 illustrated in FIG. 5A includes a positively sloped portion 517 and a negatively sloped portion 519. Positively sloped portion 517 comprises a portion of second curved portion 512-2 extending between medial point 513 and a local minimum point 521 of second curved portion 512-2. The negatively sloped portion 519 comprising a portion of second curved portion 512-2 extending between local minimum point 521 and distal point 515.

Local minimum point 521 of beam pin 504 may correspond to an approximate electrical contact point 510 at which such beam pin 504 may physically come in contact with a corresponding pin of a second connector when mated with the second connector. Extending away from its approximate electrical contact point 510, beam pin 504 may include a stub 506 corresponding to the negatively sloped portion 519. Stub 506 may have a shape or other physical features to facilitate mechanical mating of connector 500 to the second connector and adequate electrical contact between beam pins 504 and corresponding pins of the second connector.

As shown in FIGS. 5A-5C, the tip of beam pin 504 may include a layer or plating 508 applied over the body of beam pin 504 around stub 506. In some examples, plating 508 is formed from a material that has lower conductivity than the other conductive material (e.g., aluminum, copper, silver, gold, or other metal) making up the body of beam pin 504. Examples of such materials for layer or plating 508 may include tin, lead, or alloys having lower conductivity characteristics (for example, by an order of magnitude) than the other metals making up the body of beam pin 504. In some embodiments, the lower conductivity layer 508 may be applied at a skin depth depending on the frequencies of the signaling transferred or communicated over the connector. For example, for the high frequencies of next generation (e.g., in the range of 25 Gbps and higher), the skin depth can be in the range of 1 to 5 micrometers.

The layer or plating 508 may serve to dampen or reduce losses due to resonance from the stub 506. In particular, at high frequencies, the charge is usually distributed at the surface of the conductor so that the lower conductivity layer 508—rather than the higher conductivity material (e.g., gold or copper)—conducts the current in the stub 506. As such, when the lower conductivity layer 508 carries the current in stub 506, it would not carry the same amount of current as the higher conductivity material (e.g., gold or copper), thus pushing the resonance generated by the stub 506 beyond the frequency of interest. Accordingly, a resonant quarter wavelength of stub 506 comprising layer 508 may occur at significantly higher frequencies compared to a stub 506 not having such layer 508. In some embodiments, the resonance properties of stub 506 may be controlled by constructing layer 508 with physical properties (e.g., material, shape, thickness, etc.) to provide for resonance at a particular frequency. The mathematical equivalence can be explained using the equalization below:

$${Q}_{Lstub} ∝ \frac{ω {L}_{stub}}{{R}_{stub}}$$

$${Q}_{Cstub} ∝ \frac{1}{ω {C}_{stub} {R}_{stub}}$$

$${Q}_{stub} ∝ \frac{1}{\frac{1}{{Q}_{Lstub}} + \frac{1}{{Q}_{Cstub}}}$$

wherein Rstub is the resistance of stub 506, Lstub is the inductance of stub 506, Cstub is the capacitance of stub 506, ω is the angular frequency, and Qstub is the quality factor of stub 506. Qstub is dampened making it broadband. More specifically, as Rstub increases, Qstub becomes smaller and broadband in nature.

Since the purpose of the conductive beam pin 504 is to contact the corresponding pin or beam of another connector, a lower conductivity material would work even if the material of layer 508 is extended to the electrical contact point 510 making it less sensitive to manufacturing tolerances. In some examples, a side effect of such implementation may be a slight increase in loss at DC (0 Hz) and low frequencies. In some examples, many receiving components are equipped with gain and equalization circuitry, which may compensate for the DC loss and/or low frequency loss caused by overlap of layer 508 at electrical contact point 510. In contrast, equalization circuitry typically does not adequately compensate for a resonance loss.

In some embodiments, the lower conductivity plating or layer may be applied or extended to a greater portion of the beam pin, including at the electrical contact point and beyond. In some embodiments, the lower conductivity plating or layer can be applied to a blade pin (e.g., blade pin 14 described with reference to FIGS. 2A and 2B), either covering the primary stub only or a larger portion of the blade pin (including and beyond the point of contact with a mating beam pin). In some embodiments, the lower conductivity plating or layer may be applied to one or both connectors in a mating architecture, such as the blade pin and/or beam pin in a mating blade architecture (see FIGS. 2A, 2B) or one or both beam pins in the mating beam architecture (see FIGS. 3A, 3B).

One or more of these connectors, according to various embodiments of the invention, can be incorporated or employed, for example, in various sockets, pins, plugs, etc., such as QSFP28, QSFP-DD, OSFP connector systems, plated through-hole connector, surface mount connectors, co-planar connectors, orthogonal connectors, and mezzanine connectors, to reduce or eliminate the loss due to resonance attributable to a stub in the connector.

FIG. 4 shows the impact or effect on resonance when connectors according to some embodiments of the invention are used to communicate or carry signals between various electronic components. Referring to FIG. 4, a resonance loss versus frequency for an embodiment where the lower conductivity layer is applied at only the stub of a connector is illustrated by the line 404, while resonance loss versus frequency for an embodiment where the lower conductivity layer is applied to a larger portion of the beam pin (including extending beyond the electrical contact point) is illustrated by the line 406. As can be seen from FIG. 4, the connectors according to some embodiments of the invention provide for a reduction in resonance loss (by ˜30 dB) at around 25 GHz as compared to a connector without the lower conductivity layer (as illustrated by line 402). The increase in DC loss and loss at other frequencies can be compensated by the equalization at the receivers.

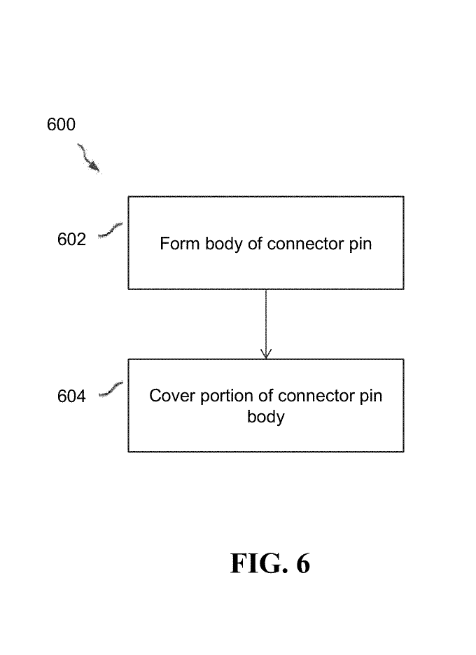

A method 600 of manufacturing a connector, in accordance with embodiments of the present disclosure is illustrated in FIG. 6. At 602, a body of a pin for the connector is formed or constructed. The body of the pin is formed from a material, such as aluminum, copper, silver, gold, or other metal or metal alloy, having a higher conductivity. In some embodiments, one or more bends or curves may be formed in the body of the pin—for example, a first concavity in one direction, and a second concavity in another direction opposite that of the first concavity (see e.g., FIG. 5A). At 604, at least a portion of the pin body is covered with a layer of material, such as lead or tin, having a lower conductivity than that of the material from which the pin body is formed. The covering layer of material can serve to dampen or reduce losses due to resonance from a “stub” when the connector is mated or joined with a second connector (see e.g., FIGS. 2B and 3B). This layer of material can be applied or formed by any suitable technique. For example, in some embodiments, the layer is formed by plating. The thickness or skin depth of the covering layer may be made such as to maximize or optimize the dampening effect on resonance losses, for example, taking into account the frequency of signaling expected or intended to be carried or communicated by the connector. In some embodiments, the thickness of the covering layer can be in the range of 1 to 5 micrometers.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A connector for transferring an information signal, comprising:
a housing; and
a pin housed in the housing and configured to electrically couple to a corresponding electrically-conductive conduit of an information handling resource comprising the connector for transferring the information signal, wherein a body of the pin is formed of a material having a first conductivity, the pin comprising:
a first portion between a proximal point of the pin and a medial point of the pin; and
a second portion between the medial point of the pin and a distal point of the pin, the medial point of the pin being proximate to a point of electrical contact of the pin with another pin, wherein the second portion is at least partially covered by a layer of material with a thickness in the range of 1 to 5 micrometers, the layer of material having a second conductivity that is lower than the first conductivity and is operable to reduce losses due to resonance that would otherwise be generated during transfer of the information signal over the connector.

2. The connector of claim 1, wherein the first portion is curved with a first concavity, and wherein the second portion is curved with a second concavity in a direction opposite the first concavity.

3. The connector of claim 1, wherein the material from which the body of the pin is formed and having the first conductivity comprises at least one of copper, aluminum, gold, or silver.

4. The connector of claim 1, wherein the layer of material at least partially covering the second portion of the pin and having the second conductivity comprises at least one of tin or lead.

5. The connector of claim 1, wherein the layer of material at least partially covering the second portion of the pin and having the second conductivity is plated to the second portion.

6. (canceled)

7. (canceled)

8. An information handling system comprising:
an information handling resource; and
a connector for transferring an information signal, coupled to the information handling resource and comprising:
a housing; and
a pin housed in the housing and configured to electrically couple to a corresponding electrically-conductive conduit of an information handling resource comprising the connector for transferring the information signal, wherein a body of the pin is formed of a material having a first conductivity, the pin comprising:
a first portion between a proximal point of the pin and a medial point of the pin; and
a second portion between the medial point of the pin and a distal point of the pin, the medial point of the pin being proximate to a point of electrical contact of the pin with another pin, wherein the second portion is at least partially covered by a layer of material with a thickness in the range of 1 to 5 micrometers, the layer of material having a second conductivity that is lower than the first conductivity and is operable to reduce losses due to resonance that would otherwise be generated during transfer of the information signal over the connector.

9. The information handling system of claim 8, wherein the first portion is curved with a first concavity, and wherein the second portion is curved with a second concavity in a direction opposite the first concavity.

10. The information handling system of claim 8, wherein the material from which the body of the pin is formed and having the first conductivity comprises at least one of copper, aluminum, gold, or silver.

11. The information handling system of claim 8, wherein the layer of material at least partially covering the second portion of the pin and having the second conductivity comprises at least one of tin or lead.

12. The information handling system of claim 8, wherein the layer of material at least partially covering the second portion of the pin and having the second conductivity is plated to the second portion.

13. (canceled)

14. (canceled)

15. A method for forming a connector for transferring an information signal, comprising:
constructing a body of a pin from a material having a first conductivity, the pin having:
a first portion between a proximal point of the pin and a medial point of the pin;
a second portion between the medial point of the pin and a distal point of the pin, the medial point of the pin being proximate to a point of electrical contact of the pin with another pin; and
at least partially covering the second portion of the pin with a layer of material with a thickness in the range of 1 to 5 micrometers, the layer of material having a second conductivity that is lower than the first conductivity and is operable to reduce losses due to resonance that would otherwise be generated during transfer of the information signal over the connector.

16. The method of claim 15, wherein the first portion is curved with a first concavity, and wherein the second portion is curved with a second concavity in a direction opposite the first concavity wherein the first portion is curved with a downward concavity, and wherein the second portion is curved with an upward concavity.

17. The method of claim 15, wherein the material from which the body of the pin is formed and having the first conductivity comprises at least one of copper, aluminum, gold, or silver.

18. The method of claim 15, wherein the layer of material at least partially covering the second portion of the pin and having the second conductivity comprises at least one of tin or lead.

19. (canceled)

20. (canceled)
